(19) United States
(12) Patent Application Publication
(10) Pub. No.: US 2026/0020578 A1
(43) Pub. Date: Jan. 22, 2026

(54) Assembly and Method for Dispensing Raw Fragmented Jerky

(71) Applicant: Robert Basgall, Wichita, KS (US)

(72) Inventor: Robert Basgall, Wichita, KS (US)

(21) Appl. No.: 19/339,810

(22) Filed: Sep. 25, 2025

(51) Int. Cl. A22C 11/02

(52) U.S. Cl. CPC A22C 11/0209

(57) ABSTRACT

A method for dispensing raw fragmented jerky including a steps of providing a sausage stuffing machine having an output port, filling the sausage stuffing machine with the raw fragmented jerky; providing a nozzle for dispensing the raw fragmented jerky, the nozzle having a longitudinally extending input end, the nozzle further having a perpendicularly extending output end, the nozzle further having an output port at a distal end of the output end; attaching the nozzle's input end in communication with the sausage stuffing machine's output port so that the nozzle extends horizontally from the sausage stuffing machine; positioning a drying frame beneath the nozzle's perpendicularly extending output end; and operating the sausage stuffing machine to dispense the raw fragmented jerky from the output port while moving the drying frame laterally.

### FIELD OF THE INVENTION

The instant invention relates to assemblies, methods, machinery, and apparatus for forming and dispensing strips of raw ground meat jerky or raw fragmented jerky for subsequent drying and dehydrating processing into a final jerky product. More particularly, this invention relates to such assemblies and methods which facilitate the jerky production via utilization of sausage stuffing machine and dehydrating machine equipment.

### BACKGROUND OF THE INVENTION

Utilization of jerky gun or jerky cannon devices to dispense raw and unprocessed ground meat jerky material or raw fragmented jerky on and over the support surface of a jerky drying tray or frame is typically ergonomically awkward and unwieldly. Such gun usage typically undesirably requires that an operator utilize both of his or her hands to wield the gun to progressively move the gun's dispensation nozzle over the food item supporting surface of the drying frame. Such jerky gun devices also commonly have a low capacity, such guns including a relatively low volume cylinder for receipt of the raw fragmented jerky material.

Sausage stuffing machines often provide a larger cylindrical volume for receipt of the raw fragmented jerky. However, such machines are typically incapable of acceptably dispensing aligned rows of jerky strips upon the support surfaces of commonly sized food dehydrator drying frames.

The instant inventive assembly and method solves or ameliorates the above-described defects and deficiencies of known raw fragmented jerky material dispensing devices by providing a specialized nozzle for use with a sausage stuffing machine and by providing specialized method steps for utilizing such nozzle in conjunction with the sausage stuffing machine for dispensing over a drying frame of series of raw jerky strips.

### BRIEF SUMMARY OF THE INVENTION

The assembly of the instant invention preferably comprises a nozzle which is adapted for forming and dispensing raw unprocessed and semi-solid ground meat jerky material (i.e. raw fragmented jerky). Prior to dehydration and drying, raw fragmented jerky commonly has a semi-solid consistency which allows pumped and extruded dispensation effected by a common sausage stuffing machine, such machine being adapted to include the instant invention's extrusion nozzle output.

The instant inventive extrusion nozzle preferably comprises a hollow bored input tube having a length between 7 inches and 15 inches. In a preferred embodiment, the input tube's hollow bore has circular cross-sectional diameter between ⅜ inches and ¾ inches, such tube suitably being composed of durable plastic. Alternatively, the nozzle's input tube may be composed of a metal material such as stainless steel, aluminum, copper, or brass. The input tube has a longitudinal extension, and during use, such tube is substantially horizontally oriented to provide a cantilevering extension over a working space. The nozzle's input tube necessarily has an oppositely longitudinal input end, the cantilevering end of such tube constituting a longitudinal output end.

A further structural component of the instant inventive assembly comprises an output tube which, similarly with the input tube, has an input end and an output end. In the preferred embodiment, the output tube's input end is fixedly attached to or formed wholly with the longitudinal end of the output tube, such attachment necessarily allowing the hollow bore of the input tube to communicate with the hollow bore of the output tube.

In a preferred embodiment, the assembly's output tube component extends substantially perpendicularly from the longitudinal output end of the input tube. An extreme distal end of the output tube necessarily forms a longitudinally oblongated output port. In such embodiment, the direction of the oblongation of the output port substantially parallels the direction of the longitudinal extension of the nozzle's input tube.

Also in the preferred embodiment, the opening of the output port has a longitudinal dimension between ½ inches and 3 inches, such dimensional range accommodating nozzle dispensations of finally formed and dried jerky strips having widths between ½ inches and 3 inches. Such output port also preferably has a circumferential dimension which is orthogonal to the port's longitudinal dimension, such circumferential dimension facilitating fabrication of jerky strips having thicknesses between ⅛ inch and 1 inch. In a preferred embodiment, as is further explained below, the nozzle's distal output port may adjustably orbit circularly about the output tube's proximal end. Accordingly, the dimension of the output port which extends orthogonally with respect to such port's longitudinal dimension constitutes the port's circumferential dimension.

A preferred embodiment of the instant inventive nozzle presents a conically flared section which opens oppositely longitudinally at the input end of the input tube, such flared end being dually adapted for receipt of the raw fragmented jerky in the manner of a funnel and for facilitating rotary adjustments of the radial extension of the output tube. Such rotary adjustments may effectively orbitally move the output tube's distal output port about a rotation axis extending along the input tube in order to effect smooth dispensation of the fragmented raw jerky. The nozzle's preferably provided flared input end advantageously additionally functions as an oppositely longitudinal half of a rotatable coupling element, such coupling facilitating alternatively fixed and rotatable attachment of the inventive nozzle to the sausage stuffing machine's output port.

In use of the instant inventive nozzle, an operator may preliminarily provide or secure the use of a sausage stuffing machine. In a preferred machine providing step, the sausage stuffing machine includes a cylinder, piston, and push rod assembly, the cylinder component of such assembly having a ground meat output port at its lower end. The sausage stuffing machine also preferably includes a linear motion actuator which is either electric motor powered or hand cranked, such actuator being adapted to drive the machine's push rod and piston downwardly against ground meat which has been preliminarily loaded by the operator into the cylinder. The machine's pushrod and piston driving action against the ground meat within the cylinder forcefully drives and extrudes the ground meat out of the machine's output port. In a preferred mode of performance of the instant inventive method, the conically flared oppositely longitudinal end of the nozzle's input tube is fixedly and rotatably attached to such sausage stuffing machine's output port by means of the provided rotary coupling.

In a preferred embodiment, the sausage stuffing machine is placed upon and supported at an upper surface of a workbench or table so that a laterally extending front or forward aspect of the sausage stuffing machine is located at or near a front or longitudinal edge of the work bench or table. Such orientation of the sausage stuffing machine advantageously longitudinally, forwardly, and substantially horizontally cantilevers the inventive nozzle over and beyond the longitudinal edge. Such extension of the nozzle advantageously establishes areas underlying the nozzle as a working space within which jerky strips may be laterally extruded upon a laterally moving drying frame.

An operator or performer of the method of the instant invention may, upon providing and positioning the sausage stuffing machine in the manner described above, access and utilize a drying rack or tray of a dehydrating machine, such frame or tray having a jerky strip supporting surface which is substantially perforate to allow drying and dehydration of both the upper and lower surfaces of strips of jerky material dispensed thereover.

Upon accessing such drying frame, the operator may position the drying frame immediately beneath the longitudinal end of the invention's nozzle component. Thereafter, the operator may actuate the sausage stuffing machine either by means of hand cranking or via operation of the machine's electric motor. Such machine actuation drives the raw fragmented jerky material out of the cylinder and through the nozzle for dispensation out of the nozzle's perpendicularly extended and longitudinally oblongated output port.

In a preferred mode of performance of the instant invention's method, the operator may preliminarily rotate and orient the nozzle's perpendicularly extending output tube so that such tube extends at an angle both downwardly and laterally. Upon commencement of dispensation of the jerky material, the operator may move the drying frame laterally beneath the nozzle's output port at a speed matching the speed of dispensation of the raw fragmented jerky material, such motion allowing a series of parallel strips of jerky to be dispensed over the frame's support surface.

The angular lateral extension of the nozzle's output tube in combination with the longitudinal elongation of such tube's output port advantageously allows the operator to freely move the frame beneath the nozzle in the lateral direction along the longitudinal edge of the bench or table for the dispensation of a series of strips of raw jerky along the lateral dimension of the drying frame. The lateral dispensation and the lateral frame motion which are facilitated by the instant invention avoid mechanical interference between the drying frame and the stuffing machine and/or work bench, advantageously preventing disruptions of the jerky strip dispensation.

In performance of the method of the instant invention, the operator may rotatably adjust the perpendicular extension of the nozzle's output tube to achieve a smooth and coordinated dispensation of the raw jerky material in strips over the drying frame.

Accordingly, objects of the instant invention include the provision of assembly and method for dispensing raw fragmented jerky which incorporate structures as described above, which arrange those structures in relation to each other in the manners described above, and which provide process steps as described above for the performance and achievement of beneficial functions described above.

Other and further objects, benefits, and advantages of the instant invention will become known to those skilled in the art upon review of the detailed description which follows, and upon review of the appended drawings.

### BRIEF DESCRIPTION OF DRAWINGS

FIG. 1 is a perspective view of nozzle, sausage stuffing machine, and dehydrating machine components which are provided and utilized in the instant inventive assembly and method.

FIG. 2 is a magnified view of a portion of the structure of FIG. 1, as indicated in FIG. 1.

FIG. 3 re-depicts a portion of the structure of FIG. 1, the view further showing a drying frame supporting a strip of dispensed raw fragmented jerky material.

FIG. 4 is a perspective view of a loaded dehydrating machine drying frame.

FIG. 5 is a magnified view of a portion of the structure of FIG. 3, as indicated in FIG. 1, the view additionally showing dispensation of raw fragmented jerky material upon an underlying drying frame.

FIG. 6 is a partial front view of the structure of FIG. 3.

FIG. 7 re-depicts the structure of FIG. 6, the view of FIG. 7 showing an alternate rotary position of a nozzle component.

FIG. 8 presents an alternate re-depiction of the structure of FIG. 6, the view of FIG. 8 showing a further alternate rotary position of the nozzle component.

### DETAILED DESCRIPTION OF THE INVENTION

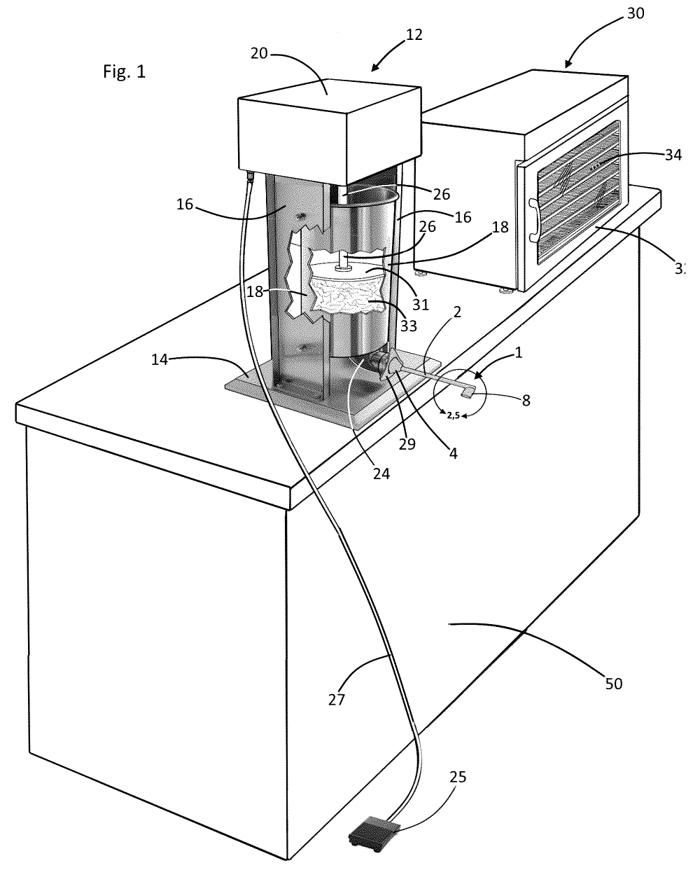

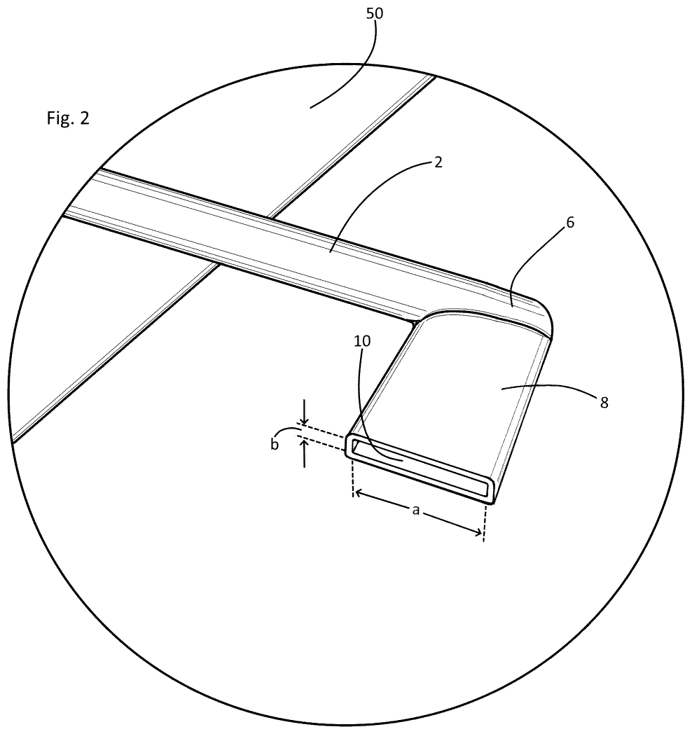

Referring now to the drawings, and in particular simultaneously to FIGS. 1 and 2, a nozzle component of the instant invention is referred to generally by reference arrow 1. The nozzle 1 comprises an input tube 2 which has circular cylindrical cross sectional shape, and has an inner hollow bore having a circular diameter between ⅜ inches and ¾ inches. The input tube 2 has, according to the view of FIG. 1, a leftwardly positioned input end or oppositely longitudinal end, and has a rightwardly positioned output end 6, such output end 6 constituting the input tube's longitudinal end. The nozzle 1 comprises an output tube 8 which is fixedly attached to or formed wholly with the longitudinal end 6 of the input tube 2, such output tube 8 having, at its distal end, an output port 10 which radially opens the output tube's hollow bore.

In the preferred embodiment, the output port 10 is longitudinally oblongated, such port configuration extending the long dimension of the port in the same direction as the longitudinal extension of the input tube 2. In a preferred embodiment, the dimension “a” of such longitudinal oblongation is between ½ inches and 3 inches, such dimensional range facilitating dispensations raw of jerky strips between ½ inches wide and 3 inches wide.

A circumferential dimension “b” (such dimension “b” extending orthogonally from dimension “a” of the output port 10) is preferably between ⅛ inches and ½ inches, such dimension matching a corresponding range of thicknesses of raw jerky strips dispensed from such port. The longitudinal end of the hollow bore of the input tube 2 necessarily communicates with the proximal end of the hollow bore of the output tube 2, such communication allowing unprocessed ground meat material or raw fragmented meat to course longitudinally though the input tube 2, and to turn substantially perpendicularly to further flow radially through the output tube 8 for outward dispensation at the longitudinally oblongated output port 10.

The oppositely longitudinal end of the nozzle's input tube 2 preferably includes or presents a conical flare 4, which may functionally receive ground meat material 33 in the manner of a funnel. The sausage stuffing machine 12 preferably comprises a base 14 which supports upwardly extending left and right frame members 16, such frame members 16 supporting an upwardly opening fragmented raw meat receiving cylinder 18.

The upwardly opening cylinder 18 is preferably downwardly opened by an output port and tube 24 which curves longitudinally to present a horizontal output opening (not depicted within views). Upon filling the lower interior space of the cylinder 18 with the unprocessed ground meat such as ground fragmented raw jerky 33, a piston element 31 may be forcefully driven downwardly within the hollow of the cylinder 18 for application of downward pressure against the meat's upper surface. A motor housing 20 supported at the upper end of the sausage stuffing machine 12 may contain and house a motor driven linear motion actuator which is adapted for downwardly driving a push rod 26 against the piston 31. Alternatively, a hand crank actuated sausage stuffing machine (not depicted within views) may be provided.

Upon operation of the sausage stuffing machine 12 for motor driven downward driving of the push rod 26 and of the piston 31 against the raw fragmented jerky material 33, portions of such material are driven downwardly and forwardly through the output port 24 to successively flow into the conical flare 4 of the input tube 2. The raw jerky 33 then flows perpendicularly into and through the output tube 8, the jerky finally dispensing as a strip extrusion from the output port 10.

An operator utilizing such sausage stuffing machine 12 with attached nozzle 1 may stand next to a work bench or table 50 upon which the sausage stuffing machine is situated. Through use of a foot actuator 25 and cable 27 assembly which is electrically attached for control of the sausage stuffing machine's motor unit 20, the operator may advantageously execute hands-free starting and stopping of the ground meat dispensation.

Prior to depressing the pedal 25 for commencement of dispensation of the raw fragmented jerky 33 from the nozzle's output tube 8, the operator may, referring simultaneously to FIGS. 1-5, open the door 32 of a provided dehydrator machine 30, and may extract one of such machine's rectangular drying frames or racks 34. Thereafter, the operator may manually position the drying frame 34 beneath the nozzle 1 so that such nozzle horizontally cantilevers over the frame's grid bars 36.

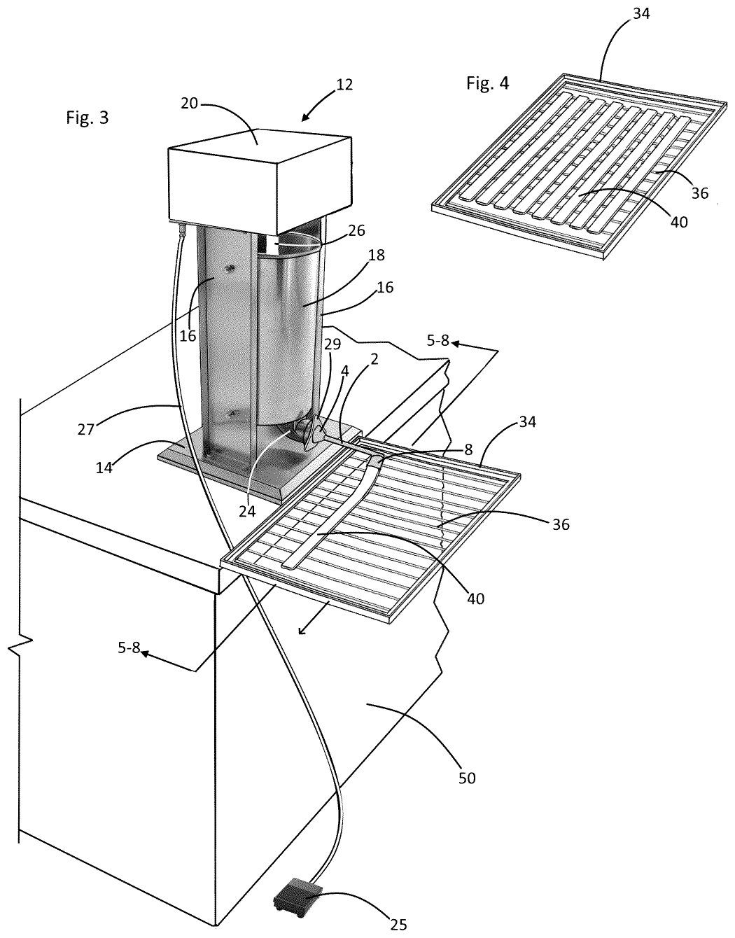

Thereafter, the operator may use his or her foot to depress pedal 35, causing the raw fragmented jerky material 33 to dispense in the form of an extruded strip 40 from the port 10. During such dispensation, the operator may manually move the drying frame 34 laterally (i.e. in the direction of the arrow drawn upon FIG. 3) at substantially the same speed as the speed of the extruded dispensation of the ground meat strip 40. Such lateral motion of the drying frame 34 may continue along the full lateral length of the drying frame without any mechanical interference between the drying frame 34 and the sausage stuffing machine 12, and without any mechanical interference with the bench or table 50.

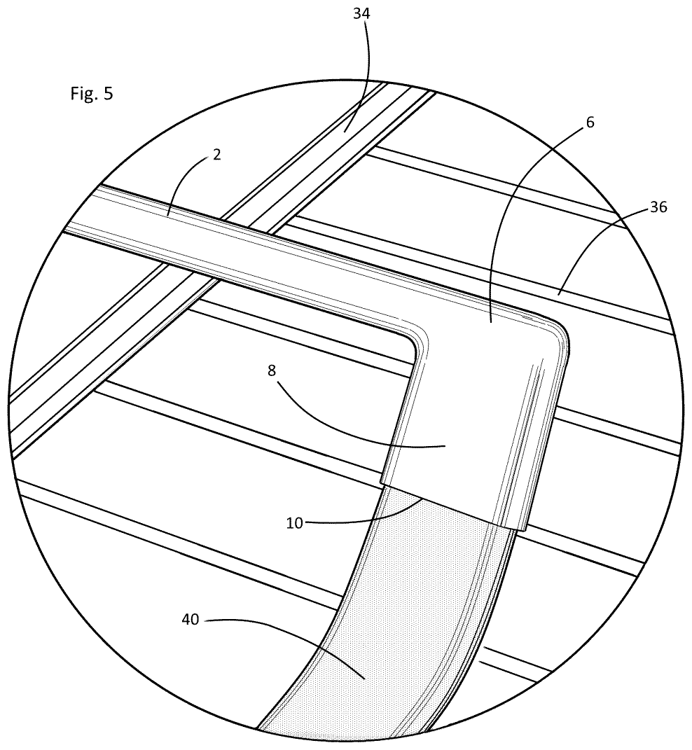

The operator may repeat steps described above for dispensing and forming, referring in particular to FIG. 4, a first quadruple of jerky strips 40. Upon executing a 180 degree rotation of the drying frame 34, the steps described above may be repeated for the formation of a second quadruple of jerky strips 40. Accordingly, the operator may substantially completely fill and cover the jerky strip supporting grid surface 36 of the drying frame 34 without any mechanical interference between the drying frame 34 and surrounding structures.

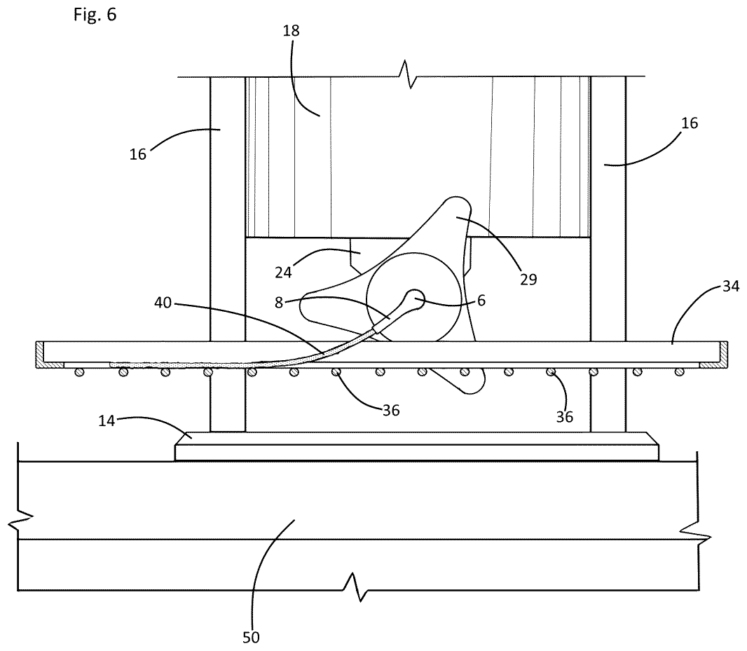

Prior to dispensing jerky strips 40 as described above, the operator may advantageously rotatably adjust the position of the nozzle 1 for the achievement of a smooth and even downwardly curved dispensation of the raw fragmented jerky as depicted in FIG. 6. To effect such dispensation, the operator may initially rotate in the counter-clockwise direction a longitudinal half 29 of a rotatable coupler. Such rotatable coupler half 29 suitably comprises an internally helically threaded coupling nut, and the oppositely longitudinal half of such rotatable coupler suitably comprises the extreme oppositely longitudinal end of the conically flared end 4 of the nozzle's input tube 2. The counter-clockwise rotation of the coupling nut 29 operatively releases fixing and mounting pressure exerted by the nut 29 against the conically flared coupler half 4.

Thereafter, the operator may rotatably adjust the angular downward and lateral position of the output tube's output port 10 in a manner calculated to achieve a smooth dispensation of strips of raw jerky material. In a preferred embodiment, the rotatable coupler's halves 4 and 29 which mount the nozzle 2 upon the sausage stuffing machine 12 facilitate selective angular positioning and repositioning of the radial extension of the output tube 8 so that such tube may extend between 30 degrees and 60 degrees below horizontal.

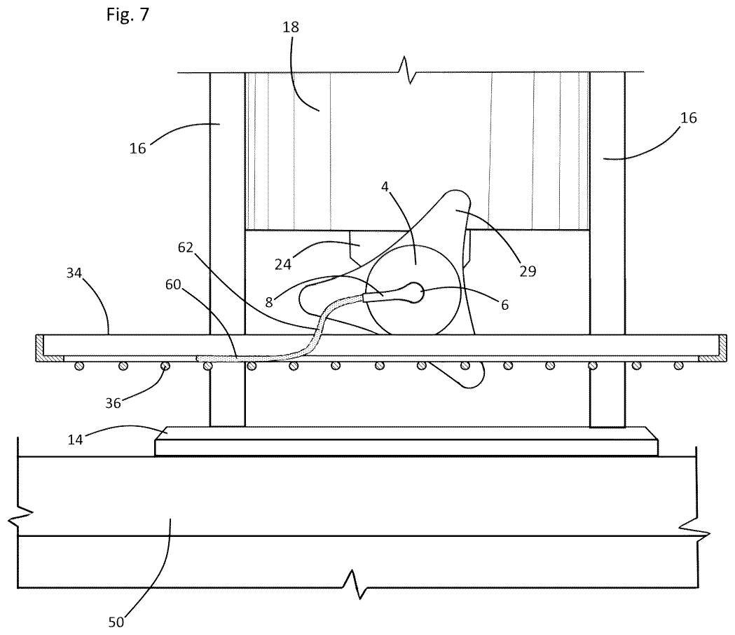

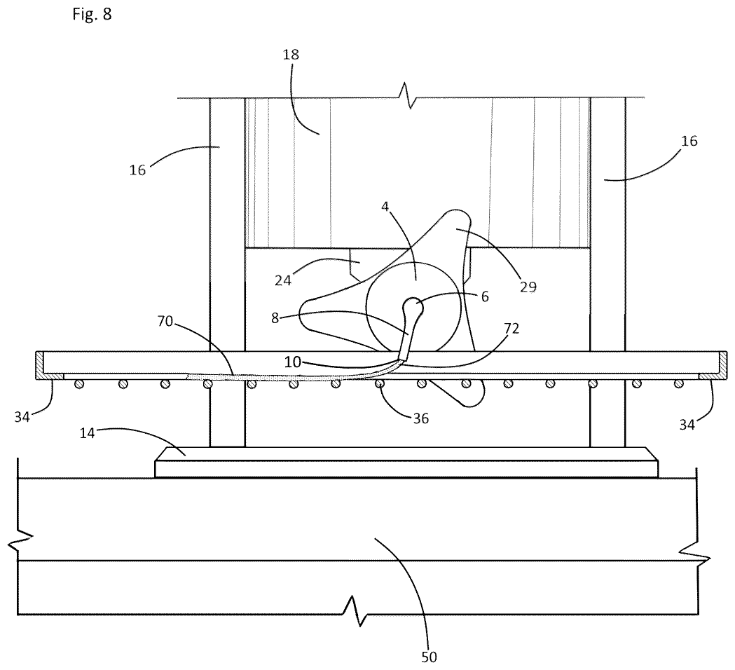

Referring to FIG. 7, the depicted angular position of the output tube 8 (e.g. less than 30 degrees below horizontal) may undesirably result in a downward “S” curved 62 dispensation of extruded raw fragmented jerky material 60. Such “S” curve dispensation may complicate and interfere with even dispensation of the jerky over the grid bars 36. Referring further to FIG. 8, an alternative angular position of the output tube 8 (e.g. greater than 60 degrees below horizontal) may undesirably produce an obtuse angle 72 of the jerky material 70 at the output port 10, instead of producing the desired smooth and tangential flow as depicted in FIG. 6. Such angular exit 72 of the jerky material 70 at port 10 may undesirably result in breakage of the strip during dispensation.

To accommodate for and prevent the undesirable “S” curve of FIG. 7 and/or the undesirable angular strip breaking point 72 of FIG. 8, the instant invention's rotatable coupler 4, 29 advantageously allows the operator to orbitally and circumferentially adjust the radial position of the output tube 8 and the output port 10 to allow a smooth and tangential dispensation of raw fragmented jerky strips 40, as depicted in FIG. 6.

While the principles of the invention have been made clear in the above illustrative embodiment, those skilled in the art may make modifications to the structure, arrangement, portions, components, and method steps of the invention without departing from those principles. Accordingly, it is intended that the description and drawings be interpreted as illustrative and not in the limiting sense, and that the invention be given a scope commensurate with the appended claims.

1. A nozzle for dispensing raw fragmented jerky, said nozzle comprising:
a. An input tube having a hollow bore, an input end, an output end, and a longitudinal extension;
b. An output tube having a hollow bore, an input end and an output end; and
c. A longitudinally oblongated port; wherein the output tube's hollow bore communicates with the input tube's hollow bore, wherein the output tube extends substantially perpendicularly from the input tube, and wherein the longitudinal oblongated output port opens the output tube's hollow bore at the output tube's output end.

2. The nozzle for dispensing raw fragmented jerky of claim 1, wherein the longitudinally oblongated output port has a longitudinal dimension between ½ inches and 3 inches.

3. The nozzle for dispensing raw fragmented jerky of claim 2, wherein the longitudinally oblongated output port has a circumferential dimension between ⅛ inches and 1 inch.

4. The nozzle for dispensing raw fragmented jerky of claim 3, wherein the input tube has a longitudinal dimension between 7 inches and 15 inches.

5. The nozzle for dispensing raw fragmented jerky of claim 4, wherein the input end of the input tube is conically flared.

6. A method for dispensing raw fragmented jerky comprising steps of:
a. Providing a sausage stuffing machine having an output port;
b. Filling the sausage stuffing machine with the raw fragmented jerky;
c. Providing a nozzle for dispensing the raw fragmented jerky, the nozzle having a longitudinally extending input end, the nozzle having an output end which extends perpendicularly from a longitudinal end of the nozzle's input end, the nozzle further having an output port positioned at a distal end of the output end;
d. Attaching the input end of the nozzle to the sausage stuffing machine's output port so that the nozzle extends substantially horizontally from the sausage stuffing machine;
e. Positioning a drying frame beneath the nozzle's perpendicularly extending output end; and
f. Operating the sausage stuffing machine to dispense the raw fragmented jerky out of the output port while moving the drying frame laterally.

7. The method for dispensing raw fragmented jerky of claim 6, wherein the nozzle's output port is longitudinally oblongated.

8. The method for dispensing raw fragmented jerky of claim 7, wherein the nozzle's output port has a longitudinal dimension between ½ inches and 1 inch.

9. The method for dispensing raw fragmented jerky of claim 8, wherein the nozzle's output port has a circumferential dimension between ⅛ inches and ¾ inches.

10. The method for dispensing raw fragmented jerky of claim 7 further comprising a step of providing a rotary coupler having a longitudinal half and an oppositely longitudinal half, wherein the rotary coupler's oppositely longitudinal half is fixedly attached to or formed wholly with the nozzle's input end, wherein and the rotary coupler's longitudinal half is operatively connected to the sausage stuffing machine's output port.

11. The method for dispensing raw fragmented jerky of claim 10, wherein the rotary coupler's oppositely longitudinal half comprises a conical flare.

12. The method for dispensing raw fragmented jerky of claim 11, wherein the rotary coupler's longitudinal half comprises a helically threaded nut.

13. The method for dispensing raw fragmented jerky of claim 10, further comprising a step of rotatably adjusting the nozzle's perpendicularly extending output end, said rotatable adjustment step being performed prior to operating the sausage stuffing machine.

14. The method for dispensing raw fragmented jerky of claim 13, wherein the rotatable adjustment of the nozzle's perpendicularly extending output end positions the output port laterally and downwardly from the longitudinal end of the nozzle's longitudinally extending input end.

15. The method for dispensing raw fragmented jerky of claim 14, wherein the rotatable adjustment of the nozzle's perpendicularly extending output end angularly positions said output end between 30 degrees and 60 degrees below horizontal.
